(19) United States
(12) Patent Application Publication
(10) Pub. No.: US 2024/0134807 A1
(43) Pub. Date: Apr. 25, 2024

(54) LOGIC CONTROL DEVICE OF SERIAL PERIPHERAL INTERFACE, MASTER-SLAVE SYSTEM, AND MASTER-SLAVE SWITCHOVER METHOD THERFOR

(71) Applicant: NETRONIX, INC., JUBEI CITY (TW)

(72) Inventors: CHUN CHIEH WANG, Jubei City (TW); CHENG YU WANG, Jubei City (TW); JIN KAI YANG, Jubei City (TW)

(21) Appl. No.: 18/048,057

(22) Filed: Oct. 19, 2022

(51) Int. Cl. G06F 13/10; G06F 13/42

(52) U.S. Cl. CPC G06F 13/10; G06F 13/4282; G06F 2213/0002

(57) ABSTRACT

The invention relates to a logic control device of a serial peripheral interface, a master-slave system and a master-slave switchover method therefor. The logic control device is connected between N masters and M slaves, and define master-slave connection relationships between each of the masters and each of the slaves. Each of the master-slave connection relationship is that each of the masters and each of the slaves transmit information one-to-one at the same time, and includes connecting the logic control device between the masters and the slaves to form the master-slave system as well as the master-slave switchover method therefor.

### FIELD OF THE INVENTION

The invention relates to a serial peripheral interface, in particular, to a logic control device of a serial peripheral interface, a master-slave system, and a master-slave switchover method therefor.

### DESCRIPTION OF THE PRIOR ART

The Serial Peripheral Interface (SPI) Bus according to Wikipedia is a synchronous serial communication interface specification for chip communication. The prior art described in Taiwan Patent No. 1701555 (hereinafter referred to as the first case) mentions that the serial peripheral interface is commonly included in mobile devices to provide synchronous serial communication between a system-on-chip (SoC) processor and various peripheral devices. The SoC serves as a master device for SPI (hereinafter referred to as a master), and each peripheral device serves as a slave device for SPI (hereinafter referred to as a slave).

The SPI bus couples the master to all of the slaves. The master supplies a clock to clock lines in the SPI bus. All serial data exchanges between the masters and the slaves are synchronized with the clock signals. The master drives data to the slave via the master output slave input (MOSI) line. Each of the slaves can share the master input slave output (MISO) online to drive data to the masters. Since the MISO line is shared by the slaves, the SPI bus also includes a chip-select line for each of the slaves to provide access protocols to the shared MISO line.

Each of the slaves has its own chip-select line, so the SPI bus at each of the slaves is a bus with four wires to accommodate clock, MOSI, MISO, and chip select signaling. However, the SPI bus at the master is a bus with (3+N) wires, where N is the number of slaves that the master is connected to and is also equal to the number of chip-select lines. Each of the wires in the SPI bus is dedicated to its own pin, so that the number of pins at the master increases with the number of the slaves to which the master is connected.

For example, as shown in FIG. 1, a state where one master 10 is connected with two slaves 12 is shown; therefore, the master 10 has to be added with one chip-select line to form two chip-select lines in total; similarly, if the master 10 is connected with three slaves 12, another chip selection line is required to be added to form three chip selection lines in total. Further, as shown in FIGS. 2 and 3, at the same time, the master 10 can only select one of the slaves 12 through the chip-select lines for data transmission. In FIG. 1, CS1 and CS2 represent the chip-select line, CLK represents the clock line, MOSI represents the master output slave input line, and MISO represents the master input slave output line. Since the slave and the master generally have the same line, which exerts the same function, other lines except the chip-select line are generally represented by the same symbol.

In addition, the first case is further described. In order to solve the problem that the number of pins at the master increases with the number of slaves connected to the master, a multiplexer and I²C interface are added to the master and the slave, respectively. However, such a method has resulted in many problems, one of which is that the original masters and slaves are discarded, which leads to increased costs and waste. Another problem is that the circuit area inside the masters and the slaves is increased since the multiplexer and the embedded inter-integrated circuit interface are added to the internal circuits of the masters and the slaves in order to reduce the chip-select lines between the masters and the slaves. Still another problem is that the masters or the slaves should additionally confirm the various electrical characteristics of the derived lines since more lines are required between the multiplexer and the embedded inter-integrated circuit Interface. Further, one more problem is that all slaves can only be connected to one master.

Since all slaves 12 can only be connected to one master 10 whether traditionally or in the first case, as shown in FIG. 4, some practitioners have developed the use of two one-to-two multiplexers 14 that are connected with each other in order to solve the above problem, wherein one one-to-two multiplexer 14 is connected to the two masters 10, and the other one-to-two multiplexer 14 is connected to the slave 12, so that a transmission path between one of the masters 10 and one of the slaves 12 can be established at the same time (as shown in FIG. 5 to FIG. 8). However, this connection method idles the other one of the masters 10 and the other one of the slaves 12 at the same time, and does not effectively utilize all the masters 10 and slaves 12.

In summary, how to enable each of the masters to connect to different one of the slaves at the same time to fully use all the masters and the slaves in the traditional state where multiple masters are connected with multiple slaves under the premise of not needing too many multiplexers is an urgent problem to be solved.

### SUMMARY OF THE INVENTION

In view of the problems in the prior art, an objective of the invention is to connect a logic control device between multiple masters and multiple slaves, and to enable the logic control device to control a connection state between each of the masters and each of the slaves at the same time.

According to the objective of the invention, a logic control device of a serial peripheral interface is provided, which includes a first logic unit, a second logic unit, a third logic unit, a fourth logic unit and a select unit, wherein the first logic unit is connected between chip-select lines of the N masters and chip-select lines of the M slaves, N and M being integers greater than or equal to two; the second logic unit is connected between clock lines of the masters and clock lines of the slaves; the third logic unit is connected between master output slave input lines of the masters and master output slave input lines of the slaves; the fourth logic unit is connected between master input slave output lines of the masters and master input slave output lines of the slaves; and logical relationships of the first logic unit, the second logic unit, the third logic unit and the fourth logic unit together define each of the master-slave connection relationships between the masters and the slaves; the select unit is connected with the first logic unit, the second logic unit, the third logic unit and the fourth logic unit, and each of the master-slave connection relationships is determined and selected to be used by the select unit; each of the master-slave connection relationships is that each of the masters simultaneously transmits information with only different one of the slaves respectively.

According to the objective of the invention, a master-slave system having the logic control device is further provided, which includes the masters, the slaves, and the logic control device, wherein each of the masters and each of the slaves are configured with a chip-select line, a clock line, a master output slave input line and a master input slave output line respectively, and each of the masters has only one chip-select line; the number of the chip-select lines of each of the masters does not increase with the number of the slaves; the logical control device is connected between each of the masters and each of the slaves, and defines the master-slave connection relationships between each of the masters and each of the slaves; each of the master-slave connection relationships is that each of the masters simultaneously transmits information with different one of the slaves respectively.

According to the objective of the invention, a switchover method for the master-slave system having the logic control device is further provided, which is applied to the master-slave system having the logic control device. The method includes steps of: providing the logic control device between the masters and the slaves, wherein the logical relationships of the first logic unit, the second logic unit, the third logic unit, and the fourth logic unit together define each of the master-slave connection relationships between the N masters and the M slaves, and each of the master-slave connection relationships is that each of the masters simultaneously transmits information with different one of the slaves respectively; confirming, by the select unit, which one of the master-slave connection relationships to use; connecting, by the logic control device, each of the masters to different one of the slaves according to the selected master-slave connection relationship.

The logic control device is a programmable logic device, and further is a simple programmable logic device (SPLD); the first logic unit, the second logic unit, the third logic unit, and the fourth logic unit are a first look-up-table (LUT) group, a second look-up-table group, a third look-up-table group, and a fourth look-up-table group of the programmable logic device or the simple programmable logic device; each of the look-up table groups has S look-up tables, wherein S is greater than or equal to M.

N and M are equal to two, i.e., there are two masters and two slaves, which are defined as a first master, a second master, a first slave, and a second slave respectively; the first look-up-table group, the second look-up-table group, the third look-up-table group, and the fourth look-up-table group have two look-up tables respectively, which define a first master-slave connection relationship and a second master-slave connection relationship, wherein the first master-slave connection relationship is that the first master transmits data with the first slave and the second master transmits data with the second slave, while the second master-slave connection relationship is that the first master transmits data with the second slave and the second master transmits data with the first slave.

The logic control device of the serial peripheral interface further includes a switch unit, wherein the switch unit is connected between the salves and the first logic unit, the second logic unit, and the third logic unit, and between the masters and the fourth logic unit; when the switch unit is turned on, the logic control device may output signals to the first logic unit, the second logic unit, the third logic unit, and the fourth logic unit; when the switch unit is turned off, the logic control device may not output signals to the first logic unit, the second logic unit, the third logic unit, and the fourth logic unit.

In summary, in the invention, the logic control device is used to control the serial peripheral Interface bus to transmit data in a one-to-one manner between each of the masters and each of the slaves at the same time, so that the problems mentioned in the prior art are completely solved.

### BRIEF DESCRIPTION OF THE DRAWINGS

FIG. 1 is a structural diagram of a circuit traditionally connecting one master with two slaves.

FIG. 2 is a diagram showing that the master is connected with one of the slaves in FIG. 1.

FIG. 3 is a diagram showing that the master is connected with the other one of the slaves in FIG. 1.

FIG. 4 is a diagram showing that a multiplexer traditionally is connected with two masters and two slaves.

FIG. 5 is a diagram showing that the first master is connected with the first slave in FIG. 4.

FIG. 6 is a diagram showing that the second master is connected with the second slave in FIG. 4.

FIG. 7 is a diagram showing that the first master is connected with the second slave in FIG. 4.

FIG. 8 is a diagram showing that the second master is connected with the first slave in FIG. 4.

FIG. 9 is a diagram of a master-slave system having the logic control device according to the invention.

FIG. 10 is a diagram showing that the first master is connected with the first slave and the second master is connected with the second slave in FIG. 9.

FIG. 11 is a diagram showing that the first master is connected with the second slave and the second master is connected with the second slave in FIG. 9.

FIG. 12 is a diagram showing that each of the masters is completely disconnected from each of the slaves in FIG. 9.

FIG. 13 is a diagram showing the connection state of a first logic unit according to the invention.

FIG. 14 is a diagram showing the connection state of a second logic unit according to the invention.

FIG. 15 is a diagram showing the connection state of a third logic unit according to the invention.

FIG. 16 is a diagram showing the connection state of a fourth logic unit according to the invention.

FIG. 17 is a diagram showing the logical relationships between a first look-up-table and a second look-up-table according to the invention.

FIG. 18 is a flow chart of a method according to the invention.

FIG. 19 is a flow chart of switchover with a switch unit according to the invention.

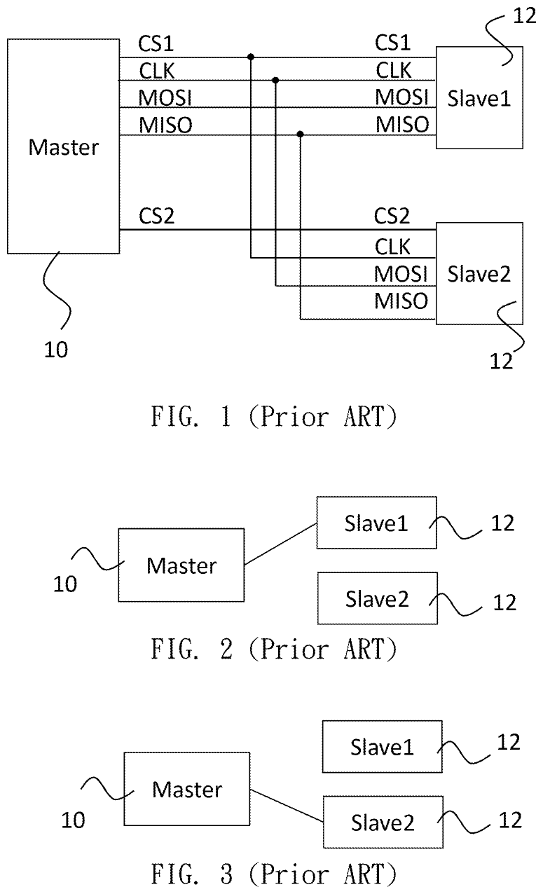

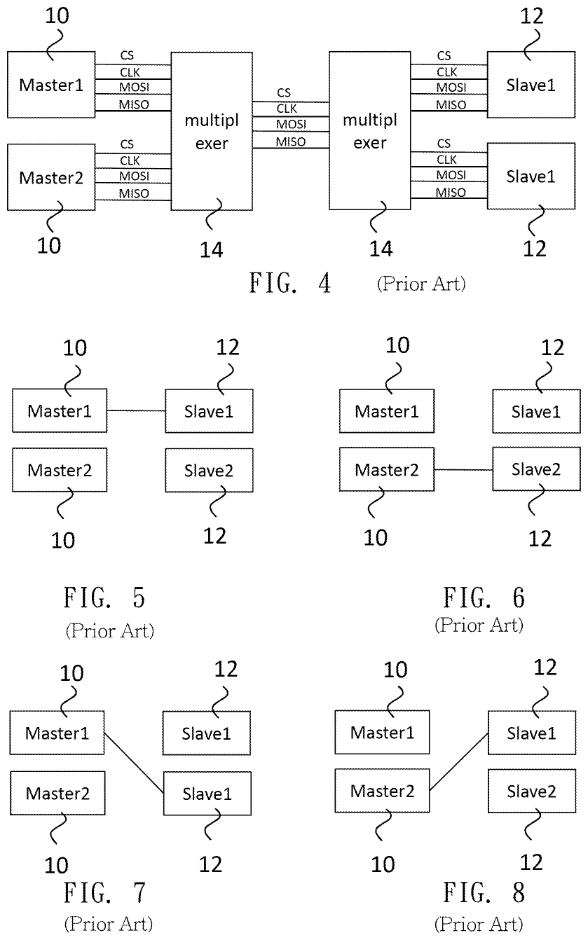

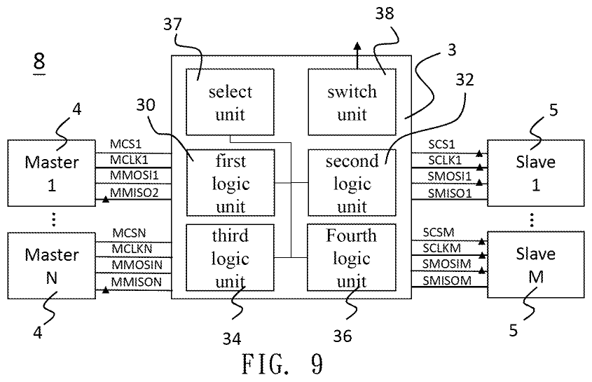

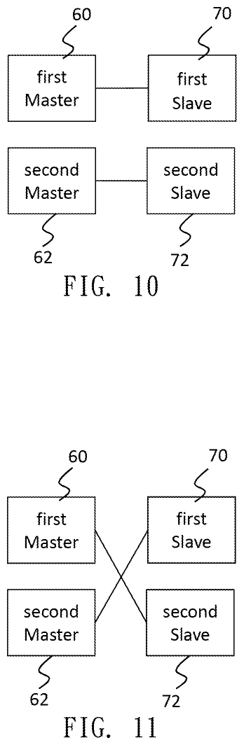

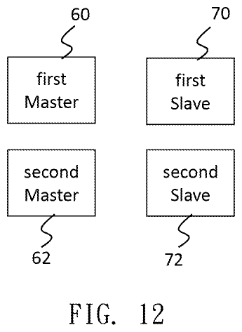

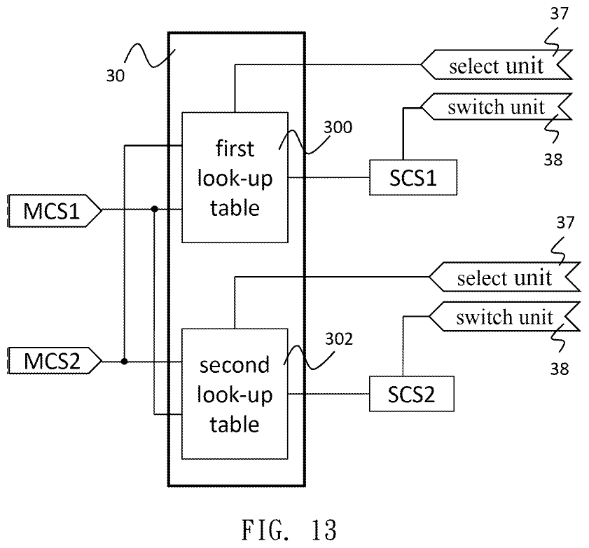

### DESCRIPTION OF THE PREFERRED EMBODIMENTS

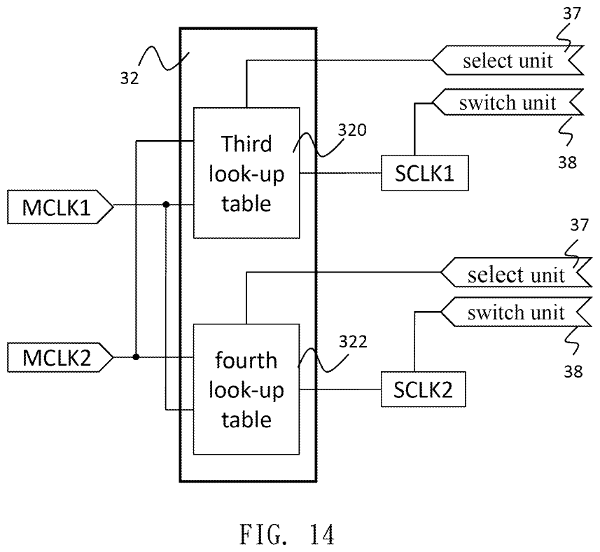

As shown in FIG. 9, the invention relates to a logic control device of a serial peripheral interface. The logic control device 3 includes a first logic unit 30, a second logic unit 32, a third logic unit 34, a fourth logic unit 36 and a select unit 37, wherein the first logic unit 30 is connected between chip-select lines (MCS1˜MCSN) of N masters 4 and chip-select lines (SCS1˜SCSM) of M slaves 5, the second logic unit 32 is connected between clock lines (MCLK1˜MCLKN) of the N masters 4 and clock lines (SCLK1˜SCLKM) of the M slaves 5, and the third logic unit 34 is connected between master output slave input line (MMOSI1˜MMOSIN) of the N masters 4 and master output slave input lines (SMOSI1˜SMOSIM) of the M slaves 5. The fourth logic unit 36 is connected between master input slave output lines (MMISO1˜MMISON) of the N masters 4 and master input slave output lines (SMISO1˜SMISOM) of the M slaves 5, and the select unit 37 is connected with the first logic unit 30, the second logic unit 32, the third logic unit 34 and the fourth logic unit 36. N and M mentioned herein are integers greater than or equal to two.

In order to allow the logic control device 3 to be switched so that each of the masters 4 and each of the slaves 5 are connected in a one-to-one manner at the same time, each of the masters 4 may further be selected to be switched and connected to a different slave 5. Therefore, in the invention, logical relationships of the first logic unit 30, the second logic unit 32, the third logic unit 34 and the fourth logic unit 36 together define a plurality of master-slave connection relationships between the N masters 4 and the M slaves 5. The select unit 37 provides the first logic unit 30, the second logic unit 32, the third logic unit 34 and the fourth logic unit 36 with input select signals to determine final logical relationships of the first logic unit 30, the second logic unit 32, the third logic unit 34 and the fourth logic unit 36 for further selecting to use one of the master-slave connection relationships, so that the logic control device 3 may simultaneously connect each of the masters 4 and each of the slaves 5 in a one-to-one manner, and each of the masters 4 may be selected to be connected to a different slave 5.

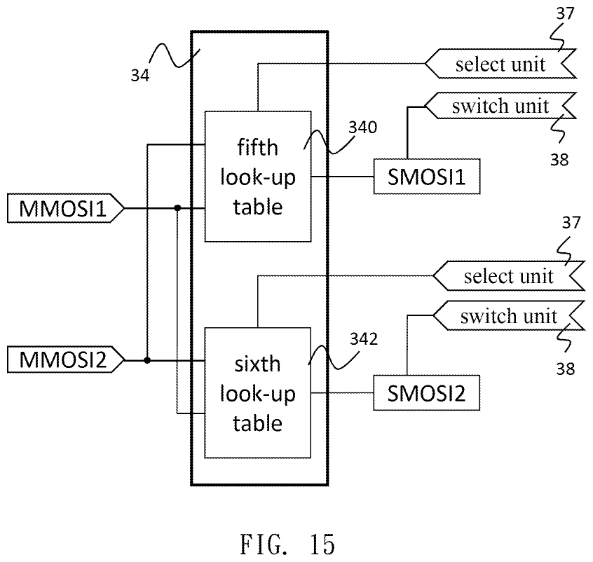

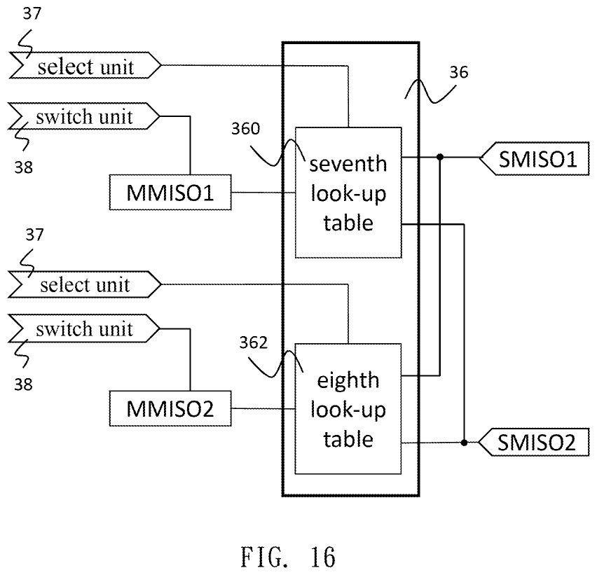

As shown in FIG. 9, the invention relates to a master-slave system having the logic control device. The master-slave system 8 includes the N masters 4, the M slaves 5 and the logic control device 3, wherein the logic control device 3 is connected between each of the masters 4 and each of the slaves 5, and both each of the masters 4 and each of the slaves 5 are configured with a chip-select line (MCS1˜MCSN, SCS1˜SCSM), a clock line (MCLK1˜MCLKN, SCLK1˜SCLKM), a master output slave input line (MMOSI1˜MMOSIN, SMOSI1˜SMOSIM) and a master input slave output line (MMISO1˜MMISON, SMISO1˜SMISOM) respectively. It should be noted that in the invention, each of the masters 4 has only one chip-select line (MCS1˜MCSN), the number of the chip-select lines (MCS1˜MCSN) of each of the masters 4 does not increase with the number of the slaves 5, and a multiplexer or an embedded inter-integrated circuit (I2C) interface is not additionally added in each of the masters 4. The logic control device 3 defines the master-slave connection relationships between each of the masters 4 and each of the slaves 5, and each of the master-slave connection relationships is that each of the masters 4 is connected to one of the different slaves 5 respectively in a one-to-one manner (as shown in FIG. 10 and FIG. 11), or each master 4 and each slave 5 are not connected to each other (as shown in FIG. 12).

In the invention, the logic control device 3 is a programmable logic device, and further is a simple programmable logic device; the first logic unit 30, the second logic unit 32, the third logic unit 34 and the fourth logic unit 36 are a first look-up-table (LUT) group, a second look-up-table group, a third look-up-table group, and a fourth look-up-table group of the programmable logic device or the simple programmable logic device; each of the look-up-table groups has S look-up tables, wherein S is greater than or equal to M. In the actual implementation of the invention, the logic control device 3 is not limited thereto, and any electronic device with a logic function may be the logic control device 3 in the invention.

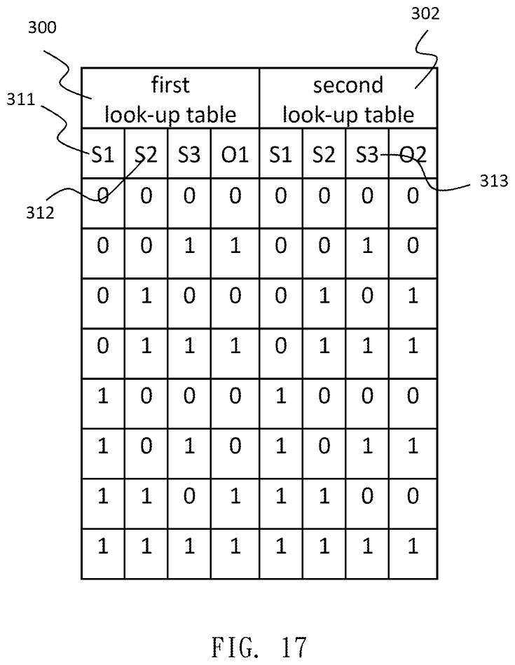

In the invention, the logic control device 3 further includes a switch unit 38. In FIG. 9, triangle symbols are used to represent the chip-select lines (SCS1˜SCSM), the clock lines (SCLK1˜SCLKM), the master output slave input lines (SMOSI1˜SMOSIM) of the switch unit 38 connected with the M slaves 5, and represent the master input slave output lines (MMISO1˜MMISON) of the switch unit 38 connected with the N masters. In FIGS. 13 to 15, the chip-select lines (SCS1˜SCSM), the clock lines (SCLK1˜SCLKM) and the master output slave input lines (SMOSI1˜SMOSIM) of the M slaves 5 are connected with the first logic unit 30, the second logic unit 32 and the third logic unit 34 respectively, and the master input slave output lines of the N masters are connected with the fourth logic unit 36. In short, as shown in FIGS. 13 to 15, the switch unit 38 is connected between the M salves 5 and the first logic unit 30, the second logic unit 32 and the third logic unit 34, and between the N masters 4 and the fourth logic unit 36; when the switch unit 38 is turned on, the logic control device 3 may output signals to the first logic unit 30, the second logic unit 32, the third logic unit 34 and the fourth logic unit 36; when the switch unit 38 is turned off, the logic control device 3 may not output signals to the first logic unit 30, the second logic unit 32, the third logic unit 34 and the fourth logic unit 36. In actual implementation, the invention is not limited to the above solutions. The switch unit 38 may also be connected between the M slaves 5 and the first logic unit 30, the second logic unit 32, the third logic unit 34 and the fourth logic unit 36, or the switch unit 38 may be connected between the N masters 4 and the first logic unit 30, the second logic unit 32, the third logic unit 34 and the fourth logic unit 36. In other words, any solutions are possible as long as the transmission of information between each of the masters 4 and each of the slaves 5 may be allowed or stopped.

In an embodiment of the invention, in order to facilitate the understanding of the invention, the invention is described under a situation where the logic control device 3 is the simple programmable logic device with Simple Programmable Logic Device of Model SLG46537V from German Merchant Dialog Semiconductor and two masters 4 as well as two slaves 5 as an example, wherein the two masters 4 and the two slaves 5 are respectively defined as a first master 60, a second master 62, a first slave 70 and a second slave 72, i.e., N and M are equal to two, and the logic control device 3 has 18 pins; the chip-select lines (MCS1˜MCSN, SCS1˜SCSM), the clock lines (MCLK1˜MCLKN, SCLK1˜SCLKM), the master output slave input lines (MMOSI1˜MMOSIN, SMOSI1˜SMOSIM) and the master input slave output lines (MMISO1˜MMISON, SMISO1˜SMISOM) of each of the masters 4 and each of the slaves 5 are connected with each of the pins respectively to form a total of 16 pins, and the other one and the last one of the pins are used for the select unit 37 and the switch unit 38 respectively.

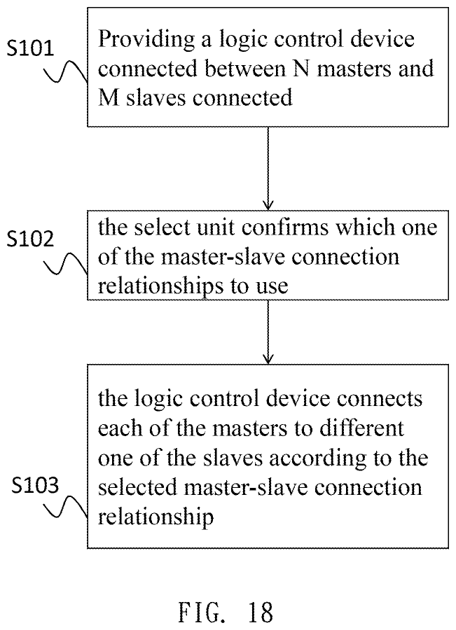

The first look-up-table group, the second look-up-table group, the third look-up-table group and the fourth look-up-table group have two look-up tables respectively, which are a first to an eighth look-up tables (300, 302, 320, 322, 340, 342, 360, 362) respectively. The logical relationships established by the first to the eighth look-up tables are all the same, and include a first variable 311, a second variable 312, and a third variable 313, wherein the first variable 311 corresponds to potential changes of the select unit 37, the second variable 312 corresponds to potential changes of the first master 60, and the third variable 313 corresponds to potential changes of the second master 62 (as shown in FIG. 14). Each of the variables of each of the look-up tables represents the potential changes with one bit, for example, 0 represents the low potential, and 1 represents the high potential. Regardless of whether the first master 60 and the second master 62 transmit information at the same time, when the potential of the first variable 311 is low, the master-slave connection relationship is that the first master 60 is selected to transmit information with the second slave 72 and the second master 62 is selected to transmit information with the first slave 70; when the potential of the first variable 311 is high, the master-slave connection relationship is that the first master 60 is selected to transmit information with the first slave 70 and the second master 62 is selected to transmit information with the second slave 72.

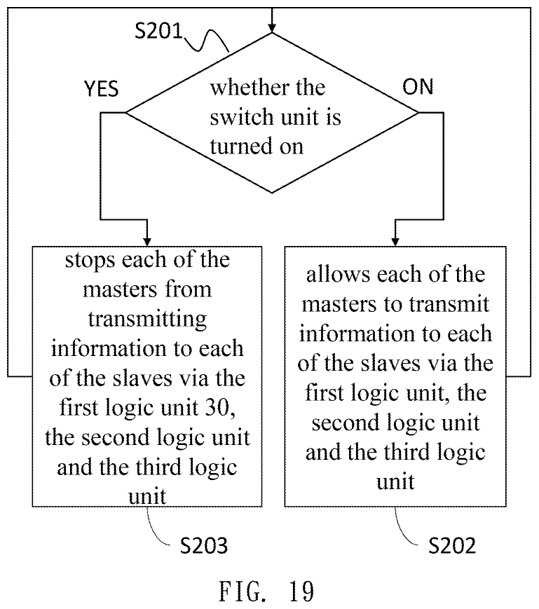

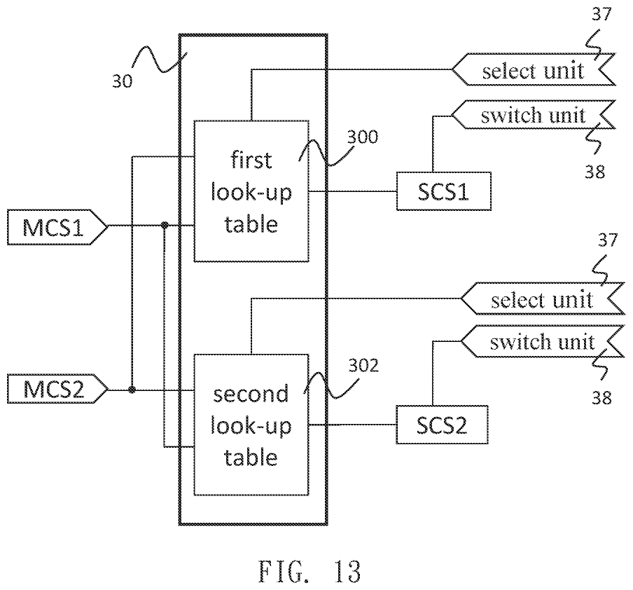

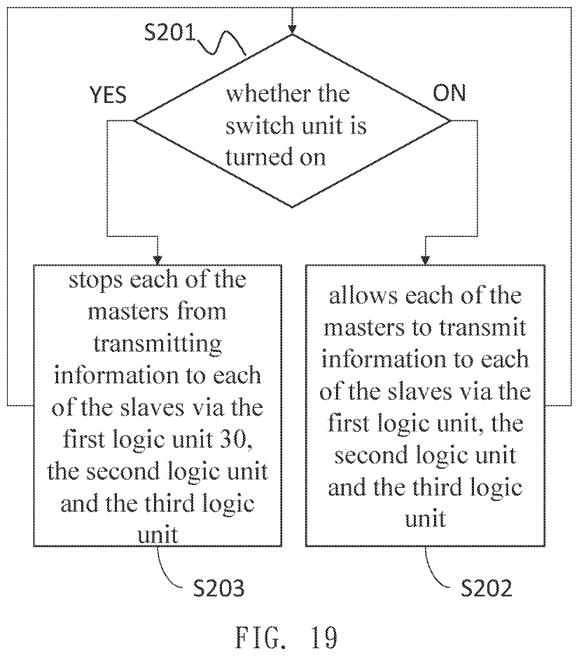

In the embodiment, when the switch unit 38 is in an enabled (high potential) state, no matter what kind of master-slave connection relationships is currently in, each of the masters 4 and each of the slaves 5 stop transmitting information with each other, no matter what kind of master-slave connection relationships is at this time. An equivalent circuit of the logic control device 3 of the embodiment is shown in FIG. 15. Each of the look-up tables receive the first variable 311, the second variable 312 and the third variable 313 so that each of the masters 4 is connected with each of the slaves 5 in an one-to-one manner FIG. 15 has already shown the line connection state in detail, so it will not be repeated here.

As shown in FIG. 16, the invention relates to a switchover method for the master-slave system having the logic control device 3, which is applied to the master-slave system 8 having the logic control device 3 and includes the following steps:
(S101) the N masters 4, the M slaves 5 and the logic control device 3 are connected, wherein the logical relationships of the first logic unit 30, the second logic unit 32, the third logic unit 34 and the fourth logic unit 36 of the logic control device 3 together define a plurality of master-slave connection relationships between the N masters 4 and the M slaves 5, and each of the master-slave connection relationships is that each of the masters 4 is connected to one of the different slaves 5 respectively;
(S102) the select unit 37 confirms which one of the master-slave connection relationships to use;
(S103) the logic control device 3 connects each of the masters 4 to different one of the slaves 5 according to the selected master-slave connection relationship.

In the invention, the logic control device 3 further includes the switch unit 38; the switch unit 38 is connected between each of the slaves and the first logic unit 30, the second logic unit 32 and the third logic unit 34, and between each of the masters 4 and the fourth logic unit 36. The logic control device 3 performs processing according to the following steps:
(S201) whether the switch unit 38 is turned on or off is checked at any time, wherein when the switch unit 38 is in turned on, the step (S202) is performed, and when the switch unit 38 is in turned off, the step (S203) is performed;
(S202) when the switch unit 38 is turned on, the logic control device 3 allows each of the masters 4 to transmit information to each of the slaves 5 via the first logic unit 30, the second logic unit 32 and the third logic unit 34, while allowing each of the slaves 5 to transmit information to each of the masters 4 via the fourth logic unit 36;
(S203) when the switch unit 38 is turned off, the logic control device 3 stops each of the masters 4 from transmitting information to each of the slaves 5 via the first logic unit 30, the second logic unit 32 and the third logic unit 34, while stopping each of the slaves 5 from transmitting information to each of the masters 4 via the fourth logic unit 36.

In summary, in the invention, the logic control device 3 is used to control each of the masters 4 and each of the slaves 5 of the serial peripheral interface bus to transmit data with each other in a one-to-one manner at the same time, which not only solves the problem that the traditional master 4 needs to be added with additional chip-select lines according to the number of slaves, but also solve the problem that any master 4 may not be selectively connected to one of the slaves 5 since the internal structure of the master 4 or the slave needs not to be changed in the invention. Further, the logic control device 3 does not need to use multiple multiplexers, so that any master 4 may be selectively connected to one of the slaves 5, and all the masters 4 may be connected to one of the slaves 5 at the same time, thereby completely solving the problems mentioned in the prior art.

What is claimed is:

1. A logic control device of a serial peripheral Interface, comprising:
a first logic unit connected between chip-select lines of N masters and chip-select lines of M slaves, wherein N and M are integers greater than or equal to two;
a second logic unit connected between clock lines of the masters and clock lines of the slaves;
a third logic unit, connected between master output slave input (MOSI) lines of the masters and MOSI lines of the slaves;
a fourth logic unit connected between master input slave output (MISO) lines of the masters and MISO lines of the slaves; and
a select unit connected with the first logic unit, the second logic unit, the third logic unit, and the fourth logic unit, respectively;
wherein logical relationships of the first logic unit, the second logic unit, the third logic unit, and the fourth logic unit together define a plurality of master-slave connection relationships between the masters and the slaves, one of the master-slave connection relationships is determined and selected to be used by the select unit, and each of the master-slave connection relationships is that each of the masters simultaneously transmits information with different one of the slaves respectively.

2. The logic control device of the serial peripheral interface according to claim 1, wherein the logic control device is a programmable logic device or a simple programmable logic device;
the first logic unit, the second logic unit, the third logic unit, and the fourth logic unit are respectively a first look-up-table group, a second look-up-table group, a third look-up-table group, and a fourth look-up-table group of the programmable logic device or the simple programmable logic device;
each of the first look-up-table group, the second look-up-table group, the third look-up-table group, and the fourth look-up-table group has S look-up tables, wherein S is greater than or equal to M.

3. The logic control device of the serial peripheral interface according to claim 2, wherein when N, M, and S are equal to two, the masters and the slaves are respectively defined as a first master, a second master, a first slave, and a second slave;
the look-up tables of the first look-up-table group, the second look-up-table group, the third look-up-table group, and the fourth look-up-table group define a first master-slave connection relationship and a second master-slave connection relationship;
the first master-slave connection relationship is that the first master is connected to the first slave, and the second master is connected to the second slave;
the second master-slave connection relationship is that the first master is connected to the second slave, and the second master is connected to the first slave.

4. The logic control device of the serial peripheral interface according to claim 3, further comprising a switch unit, wherein the switch unit is connected between the salves and the first logic unit, the second logic unit, and the third logic unit, and between the masters and the fourth logic unit;
when the switch unit is turned on, the logic control device may output signals to the first logic unit, the second logic unit, the third logic unit, and the fourth logic unit;
when the switch unit is turned off, the logic control device may not output signals to the first logic unit, the second logic unit, the third logic unit, and the fourth logic unit.

5. A master-slave system having a logic control device, comprising:
N masters and M slaves, wherein N and M are integers greater than or equal to two, each of the masters and each of the slaves are configured with a chip-select line, a clock line, a MOSI line, and a MISO line, respectively, and a number of the chip-select lines of the masters does not increase with the number of the slaves; and
a logic control device connected between the masters and the slaves and defining a plurality of master-slave connection relationships between the masters and the slaves, wherein each of the master-slave connection relationships is that the masters are connected with different one of the slaves respectively.

6. The master-slave system having the logic control device according to claim 5, wherein the logic control device comprises:
a first logic unit connected between the chip-select lines of the masters and the chip-select lines of the slaves;
a second logic unit connected between the clock lines of the masters and the clock lines of the slaves;
a third logic unit connected between the MOSI lines of the masters and the MOSI lines of the slaves;
a fourth logic unit, connected between MISO lines of the masters and MISO lines of the slaves; and
a select unit connected with the first logic unit, the second logic unit, the third logic unit, and the fourth logic unit, respectively;
wherein logical relationships of the first logic unit, the second logic unit, the third logic unit, and the fourth logic unit together define each of the master-slave connection relationships between the masters and the slaves, one of the master-slave connection relationships is determined and selected to be used by the select unit, and each of the master-slave connection relationships is that each of the masters simultaneously transmits information with different one of the slaves respectively.

7. The master-slave system having the logic control device according to claim 6, wherein the logic control device is a programmable logic device or a simple programmable logic device;
the first logic unit, the second logic unit, the third logic unit, and the fourth logic unit are respectively a first look-up-table group, a second look-up-table group, a third look-up-table group, and a fourth look-up-table group of the programmable logic device or the simple programmable logic device;
each of the first look-up-table group, the second look-up-table group, the third look-up-table group, and the fourth look-up-table group has S look-up tables, and S is greater than or equal to M.

8. The master-slave system having the logic control device according to claim 7, wherein when N, M, and S are equal to two, the masters and the slaves are respectively defined as a first master, a second master, a first slave, and a second slave;
the look-up tables of the first look-up-table group, the second look-up-table group, the third look-up-table group, and the fourth look-up-table group respectively define a first master-slave connection relationship and a second master-slave connection relationship;
the first master-slave connection relationship is that the first master is connected to the first slave, and the second master is connected to the second slave;
the second master-slave connection relationship is that the first master is connected to the second slave, and the second master is connected to the first slave.

9. The master-slave system having the logic control device according to claim 8, wherein the logic control device further comprises a switch unit;
the switch unit is connected between the salves and the first logic unit, the second logic unit, and the third logic unit, and between the masters and the fourth logic unit;
when the switch unit is turned on, the logic control device may output signals to the first logic unit, the second logic unit, the third logic unit, and the fourth logic unit;
when the switch unit is turned off, the logic control device may not output signals to the first logic unit, the second logic unit, the third logic unit, and the fourth logic unit.

10. A switchover method of a master-slave system having a logic control device, comprising steps of:
providing the logic control device connected between N masters and M slaves, wherein logical relationships of the first logic unit, the second logic unit, the third logic unit, and the fourth logic unit configured in the logic control device together define a plurality of master-slave connection relationships between the masters and the slaves, each of the master-slave connection relationships is that each of the masters simultaneously transmits information with different one of the slaves respectively, and N and M are integers greater than or equal to two;
selecting one of the master-slave connection relationships by a select unit configured in the logic control device; and
by the logic control device, determining each of the masters to simultaneously and respectively transmit information with different one of the slaves according to the master-slave connection relationship that is selected.

11. The switchover method of the master-slave system having the logic control device according to claim 10, wherein the logic control device further comprises a switch unit; the switch unit is connected between the salves and the first logic unit, the second logic unit, and the third logic unit, and between the masters and the fourth logic unit; the logic control device performs processing according to steps of:
checking whether the switch unit is turned on or off;
when the switch unit is turned on, the logic control device allows each of the masters to transmit information to each of the slaves via the first logic unit, the second logic unit, and the third logic unit, while allowing each of the slaves to transmit information to each of the masters via the fourth logic unit; and
when the switch unit is turned off, the logic control device stops each of the masters from transmitting information to each of the slaves via the first logic unit, the second logic unit, and the third logic unit, while stopping each of the slaves from transmitting information to each of the masters via the fourth logic unit.
